(19) United States
(12) Patent Application Publication
(10) Pub. No.: US 2020/0239752 A1
(43) Pub. Date: Jul. 30, 2020

(54) A TWO-COMPONENT POLYURETHANE ADHESIVE

(71) Applicant: BASF SE, Ludwigshafen am Rhein (DE)

(72) Inventor: Achim KAFFEE, Trostberg (DE)

(73) Assignee: BASF SE, Ludwigshafen am Rhein (DE)

(21) Appl. No.: 16/755,379

(22) PCT Filed: Oct. 16, 2018
(86) PCT No.: PCT/EP2018/078138

§ 371 Date: Apr. 10, 2020

(30) Foreign Application Priority Data
Oct. 17, 2017 (EP) 17196871.2

(51) Int. Cl. C09J 175/08; C08G 18/12; C08G 18/48; C08G 18/76; C08G 18/20; F03D 1/06

(52) U.S. Cl. CPC C09J 175/08; C08G 18/12; C08G 18/4829; C08G 18/4879; F03D 1/0675; C08G 18/7657; C08G 18/7621; C08G 18/2063; C08G 18/4891

(57) ABSTRACT

Described herein is a two-component polyurethane adhesive that exhibits a glass transition temperature (Tg) of ≥70° C. and an open time in the range of ≥45 to ≤90 minutes at a temperature of ≥70° C. and a relative humidity of 50%. Also described is a method of producing the two-component polyurethane adhesive having a long open time with good humidity tolerance which is suitable for bonding large and bulky components or surfaces, including but not limited to, rotor blades of wind turbines.

### FIELD OF THE INVENTION

The present invention relates to a two-component polyurethane adhesive that exhibits a glass transition temperature (Tg) of ≥70° C. and an open time in the range of ≥45 to ≤90 minutes at a temperature of 23° C. and a relative humidity of 50%. The present invention also relates to a method of producing the two-component polyurethane adhesive having a long open time with good humidity tolerance which is suitable for bonding large and bulky substrates or surfaces, including but not limited to, rotor blades of wind turbines.

### BACKGROUND OF THE INVENTION

Huge articles are manufactured by assembling large prefabricated composite substrates, including for example but not limited to, rotor blades of wind turbines, construction of watercrafts, sandwich panels for refrigerated vehicles, containers and superstructures (caravans, trucks) or laying large area of floorings. Within the last decades, a demand has increased for adhesives with a high e-modulus to join such composite substrates. Initial technical solutions were based on epoxy resin systems, but within the last few years the activities to meet the required properties with an adhesive based on a polyurethane have surged as it displays better mechanical properties compared to epoxy based adhesive. In addition, adhesives based on polyurethane display an improved curing performance at ambient conditions. Hence, a polyurethane reactive adhesive, particularly a two-component polyurethane adhesive, is always a preferred choice to bond composite substrates.

The joint strength and the performance under dynamical load are important parameters for the two-component polyurethane adhesives to be used as structural adhesives which are currently in high demand. These properties are dependent on the raw materials. The high strength is usually directly proportional to the degree of crosslinking. The mechanical properties depend on:
1. Types of polyols used, their molecular weight and their functionality;
2. Types of polyisocyanates used, their functionality and NCO content;
3. The concentration of urethane and/or urea groups; and
4. The crosslinking density yielded by the interplay of the molecular weights and functionalities of all the components.

WO 2009/080740 A1 discloses a two-component polyurethane adhesive having a characteristic combination of a high molecular polyester diol, highly functional (i.e. at least 3 to 14 functional) polyols, a hydrophobic polyol and other auxiliary substances as a polyol component and polyisocyanate. This is specifically used joining substrates with uneven surfaces of bridging crevices or interspaces with a strong adhesive bond. The adhesive has an open time of more than 30 minutes and a glass transition temperature (Tg) in the range of ≥50° C. to ≤130° C. The examples 1 and 2 exhibit the glass transition temperature of 55° C. and 60° C., respectively. However, this adhesive has a high rigidity with values of e-modulus of more than 2000 MPa. The Tg and the high mechanical properties are achieved due to a selection of polyfunctional polyols and a hydrophobic polyol which results into a hydrophobic network.

EP 2655466 B1 describes a two-component polyurethane composition having a polyisocyanate component and a polyol component, in which the polyol component is a blend of castor oil, an alkoxylated aromatic diol, and a polyol with 5 to 8 hydroxyl groups. The examples 1 and 2 exhibit open times of 63 and 57 minutes, respectively, and a glass transition temperature of 57 and 55° C., respectively. This adhesive has a high rigidity with values of the e-modulus being 1700 and 1750 MPa for the examples 1 and 2, respectively.

US 2015/0247045 A1 describes a two-component polyurethane adhesive having a polyol component and an isocyanate component, in which the polyol component is a blend of oleochemical polyol with molecular weight more than 500 g/mol, a 3 to 14 functional polyol, ethoxylate or propoxylated polyphenols and a further polyol. The isocyanate component contains an aromatic as well as an aliphatic polyisocyanate in an NCO/OH ration of 0.9:1 to 1.5:1, with the adhesive having a Tg of 65° C. or more.

WO 2014/089210 A1 describes a curable precursor composition for a polyurethane adhesive which comprises a polyisocyanate in combination with a polyol with blends of triols and tetrols, optionally with pentols or polyols having 5 to 12 hydroxyl groups. The composition also comprises, a curing catalyst which is a combination of bismuth, zinc and zirconium salts. The open time is at least 30 minutes at ambient conditions, i.e. a temperature of 23° C.±3° C. and 50% relative humidity. The e-modulus is 1000 MPa. However, metal salts, in particular even in small amounts, reduce the open time, i.e. the pot life, sometimes considerably.

The open time is essentially determined by the reactivity and functionality of the starting material, the fillers that are present in the formulation and the functionality of the starting material and processing conditions, i.e. temperature and mixing technology. After adding and mixing the polyol and isocyanate component, the setting reaction commences with the formation of urethane groups, and, in case amine functionalities are present as well, additionally with the formation of urea groups. As isocyanate reacts with moisture/humidity, the polyurethane adhesive composition should be processed within few minutes. For large composite substrates like rotor blades of wind turbine, the polyurethane adhesive should have sufficient long open time in combination with good humidity tolerance.

The curing time is also determined by the same parameters as that of the open time. At room temperature, complete curing takes up to several months. This can be accelerated by external heating and catalysis which may increase the final bond strength.

The open time (maximum duration an adhesive should be processed after mixing) of a thermoset material interacts with the curing time required to meet a certain conversion rate. Therefore, the processor is interested in a system with an open time of some hours combined with a curing time of a few minutes or even seconds. An epoxy based adhesive meets the required fast curing because the reaction order of a state of the art adhesive is <2, whereas adhesives based on polyurethane display a reaction order of approximate 2. Therefore, many polyurethane-based adhesives contain catalysts to accelerate the curing process.

Therefore, there is a need to provide a two-component polyurethane adhesive which has sufficiently long open time combined with a short curing time while maintaining other favorable characteristics, such as excellent mechanical properties, i.e. excellent bonding strength.

### OBJECT OF THE INVENTION

The main objective of the invention is to provide a two-component polyurethane adhesive which has a sufficiently long open time, i.e. an open time of ≥45 minutes, and a sufficiently short curing time which shows a sufficiently high glass transition temperature of ≥65° C. which is a requirement of the regulatory authorities and excellent bonding strength.

### SUMMARY OF THE INVENTION

It has now been found that, surprisingly, the two-component polyurethane adhesive of the present invention provide an optimum balance between mechanical properties such as glass transition temperature and bonding strength and dynamical properties such as open time and curing time.

Accordingly, in one aspect, the presently claimed invention is directed to a two-component polyurethane adhesive comprising:
i. at least one polyol component (C1) comprising:
   a) ≥8 to ≤30 wt. % of at least polyether polyol (P1) having a functionality of 4;
      wherein the at least one polyether polyol (P1) is represented by the following formula (I);

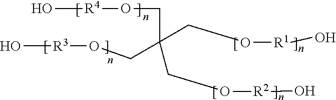

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2), and
c) ≥20 to 70 wt.-% of at least one polyol derived from a natural oil polyol (P3),
   whereby the weight percentages relate in each case to the overall amount of the polyol component (C1); and
ii. at least one isocyanate component (C2);

whereby the two-component polyurethane adhesive exhibits a glass transition temperature of ≥70° C., the glass transition temperature being determined by a DSC measurement according to DIN 11357 at a heating rate of 20° C./min.

In another aspect, the presently claimed invention relates to a two-component polyurethane adhesive comprising:
i. at least one polyol component (C1) comprising:
   a) ≥8 to ≤30 wt. % of at least polyether polyol (P1) having a functionality of 4;
      wherein the at least one polyether polyol (P1) is represented by the following formula (I);

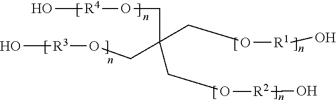

wherein R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2) and
c) ≥20 to ≤70 wt. % of at least one polyol derived from a natural oil polyol (P3), whereby the weight percentages relate in each case to the overall amount of the polyol component (C1);
and
ii. at least one aromatic polyisocyanate;

whereby the two-component polyurethane adhesive exhibits a glass transition temperature of ≥70° C., the glass transition temperature being determined by a DSC measurement according to DIN 11357 at a heating rate of 20° C./min.

In one embodiment of the presently claimed invention, R¹, R², R³ and R⁴ each, identical or different, are selected from the group consisting of —CH₂—CH₂— and —CH(CH₃)—CH₂—. In another embodiment of the presently claimed invention, R¹, R², R³ and R⁴ each are —CH₂—CH₂—. In yet another embodiment of the presently claimed invention, R¹, R², R³ and R⁴ each are —CH₂—CH(CH₃)—.

In another embodiment of the presently claimed invention, n each, identical or different, is a real number in the range of ≥1 to ≤4. In another embodiment of the presently claimed invention, n each, identical or different, is a real number in the range of ≥2 to ≤4.

In another embodiment of the presently claimed invention, the at least one polyether polyol (P1) having the functionality of 4 has a hydroxyl number in the range of ≥150 to ≤700 mg KOH/g.

In another embodiment of the presently claimed invention, the at least one polyol component (C1) comprises ≥10 to ≤25 wt. % of the at least one polyether polyol (P1), whereby the weight percentage relates to the overall amount of the polyol component (C1).

In another embodiment of the presently claimed invention, the at least one polyol containing an aromatic moiety (P2) has a hydroxyl number in the range of ≥130 to ≤340 mg KOH/g.

In another embodiment of the presently claimed invention, the at least one polyol component (C1) comprises ≥5 to ≤15 wt. % of the at least one polyol containing an aromatic moiety (P2), whereby the weight percentage relates to the overall amount of the polyol component (C1).

In another embodiment of the presently claimed invention, the at least one polyol derived from a natural oil polyol (P3) has a hydroxyl number in the range of ≥150 to ≤250 mg KOH/g.

In another embodiment of the presently claimed invention, the at least one polyol component (C1) comprises ≥25 to ≤60 wt. % of the at least one polyol derived from a natural oil polyol (P3), whereby the weight percentage relates to the overall amount of the polyol component (C1).

In another embodiment of the presently claimed invention, the at least one polyol component (C1) comprises ≥10 to ≤25 wt. % of the at least one polyether polyol (P1), ≥5 to ≤15 wt. % of the at least one polyol containing the bisphenol-A or bisphenol-F moiety (P2) and ≥25 to ≤60 wt. % of the at least one polyol derived from a natural oil polyol (P3), whereby the weight percentages relate to the overall amount of the polyol component (C1).

In another embodiment of the presently claimed invention, the at least one isocyanate component (C2) is an aromatic polyisocyanate.

In another embodiment of the presently claimed invention, the at least one isocyanate component (C2) is a mixture of an aromatic polyisocyanate, preferably polymeric methylene diphenyl isocyanate, and an aliphatic polyisocyanate, preferably hexamethylene 1,6-diisocyanate and its isocyanurates and biurets.

Accordingly, in another embodiment of the presently claimed invention, the aromatic polyisocyanate further comprises at least one deactivator.

In another embodiment of the presently claimed invention, the at least one deactivator is selected from the group consisting of an aliphatic and an aromatic acid chloride selected from the group consisting of acetyl chloride, benzoyl chloride, benzene sulfonyl chloride, oxalyl chloride, adipyl chloride, sebacyl chloride and carbonyl chloride; an inorganic acid selected from the group consisting of perchloric acid; an organic acid selected from the group consisting of trifluoromethane sulfonic acid and trifluoroacetic acid; and a chloroformate selected from the group consisting of methyl chloroformate, ethyl chloroformate, isopropyl chloroformate, n-butyl chloroformate, sec-butyl chloroformate and diethylene glycol bischloroformate.

In another embodiment of the presently claimed invention, the deactivator is preferably diethylene glycol bischloroformate.

In another embodiment of the presently claimed invention, the aromatic polyisocyanate is selected from the group consisting of polymeric methylene diphenyl isocyanate and polymeric toluene diisocyanate.

In another embodiment of the presently claimed invention, the adhesive comprises ≥0.05 to ≤1.0 wt. % of at least one heat activated catalyst, whereby the weight percentage relates to the overall amount of the polyol component (C1).

In another embodiment of the presently claimed invention, the at least one heat activated catalyst is a cyclic tertiary amine.

In another embodiment of the presently claimed invention, the cyclic tertiary amine is selected from the group consisting of 1,8-diaza-bicyclo[5.4.0]undec-7-ene, 1,5-diaza-bicyclo[4.3.0]non-5-ene, 1,4-diazabicyclo[2.2.2]octane, N-cetyl-N,N-dimethylamine and dimethylcyclohexylamine.

In another embodiment of the presently claimed invention, the cyclic tertiary amine is blocked 1,8-diaza-bicyclo[5.4.0]undec-7-ene.

In another embodiment of the presently claimed invention, said adhesive comprises ≥10 to ≤40 wt. % of at least one additive, whereby the weight percentage relates to the overall amount of the polyol component (C1).

In another embodiment of the presently claimed invention, the at least one additive is selected from the group consisting of chain extenders, water scavengers, fillers, deaerating agents, thixotropic agents, antioxidants, dyes, catalysts, desiccants, resins, plasticizers, wetting agents and pigments.

In a preferred embodiment of the presently claimed invention, the two-component polyurethane adhesive exhibits a glass transition temperature in the range of ≥70 to ≤90° C., the glass transition temperature being determined by the DSC measurement according to DIN 11357 at the heating rate of 20° C./min.

In another embodiment of the presently claimed invention, the two-component polyurethane adhesive exhibits an open time in the range of ≥45 to ≤90 minutes, preferably in the range of ≥50 to ≤90 minutes, at a temperature of 23° C. and a relative humidity of 50%, the open time being determined by a rheometer according to compression test by applying a force of 25 N and a velocity of 0.1 mm/s.

Accordingly, in another aspect, the presently claimed invention is directed to a method for producing the two-component polyurethane adhesive, wherein the method comprises the steps of
A. providing at least one polyol component (C1) comprising
   a) ≥8 to ≤30 wt. % of at least polyether polyol (P1) having a functionality of 4;
      wherein the at least one polyether polyol (P1) is represented by the following formula (I);

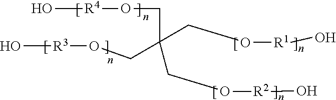

Wherein
R¹, R2², R³ and R⁴ each, identical or different, are selected from the group consisting of —CH₂—CH₂—, —CH(CH₃)—CH₂—, —CH(C₂H₅)—CH₂—, —C(CH₃)₂—CH₂—, and —CH₂—CH₂—CH₂— and
n each, identical or different, is a real number in the range of ≥1 to ≤6,
b) ≥5 to ≤20 wt.-% of at least one polyol containing an aromatic moiety (P2), and
c) ≥20 to ≤70 wt.-% of at least one polyol derived from a natural oil polyol(P3), whereby the weight percentages relate in each case to the overall amount of the polyol component (C1);
B. providing at least one isocyanate component (C2);
C. adding at least one deactivator to the at least one isocyanate component (C2) of step (B); and
D. mixing the at least one polyol component (C1) of step (A) with the at least one isocyanate component (C2) of step (C) at an index in the range of ≥102 to ≤108;

to obtain the two-component polyurethane adhesive exhibiting a glass transition temperature of ≥70° C., the glass transition temperature being determined by a DSC measurement according to DIN 11357 at a heating rate of 20° C./min.

In another embodiment of the presently claimed invention, mixing the at least one polyol component (C1) of step (A) with the at least one isocyanate component (C2) of step (C) is carried out at the index in the range of ≥102 to ≤106.

Another aspect of the present invention relates to a method for producing the two-component polyurethane adhesive, wherein the method comprises the steps of
A. providing at least one polyol component (C1) comprising
   a) ≥8 to ≤30 wt. % of at least polyether polyol (P1) having a functionality of 4;
      wherein the at least one polyether polyol (P1) is represented by the following formula (I);

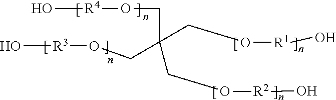

Wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂—, and —CH₂—CH₂—CH₂— and
n each, identical or different, is a real number in the range of ≥1 to ≤6,
b) ≥5 to ≤20 wt-% of at least one polyol containing an aromatic moiety (P2), and
c) ≥20 to ≤70 wt-% of at least one polyol derived from a natural oil polyol(P3), whereby the weight percentages relate in each case to the overall amount of the polyol component (C1);
B. providing at least one aromatic polyisocyanate;
C. adding at least one deactivator to the at least one aromatic polyisocyanate of step (B); and
D. mixing the at least one polyol component (C1) of step (A) with the at least one aromatic polyisocyanate of step (C) at an index in the range of ≥102 to ≤108;

to obtain the two-component polyurethane adhesive exhibiting a glass transition temperature of ≥70° C., the glass transition temperature being determined by a DSC measurement according to DIN 11357 at a heating rate of 20° C./min.

In another embodiment of the presently claimed invention, mixing the at least one polyol component (C1) of step (A) with the at least one aromatic polyisocyanate of step (C) is carried out at the index in the range of ≥102 to ≤106.

Accordingly, in another aspect, the presently claimed invention is directed to an article comprising at least one first substrate and one second substrate, wherein the two-component adhesive according to the claimed invention or obtained according to the method of the claimed invention is present in-between the first substrate and the second substrate of the article and forms an adhesive bond between them.

In another embodiment of the presently claimed invention, the article is a rotor blade for the wind turbines and the first substrate and the second substrate are the first and the second halves of the rotor blades, respectively.

Accordingly, in one preferred aspect, the presently claimed invention is directed to a method of manufacturing an article, wherein the method comprises the steps of:
E. applying the two-component polyurethane adhesive according to the claimed invention or obtained according to the method of the claimed invention onto a first substrate of the article and a second substrate of the article;
F joining the first substrate of the article of step (E) to the second substrate of the article of step (E); and
G. curing the two-component polyurethane adhesive at a temperature in the range of ≥50 to ≤90° C., preferably ≥60 to ≤70° C., to form a bond between the first and the second substrate of the article.

In a preferred embodiment, an article, preferably the rotor blades of a wind turbine, preferably comprises more than two substrates, preferably a part of a rotor blade of a wind turbine. In case an article comprises more than two substrates, i.e. 3, 4, 5, 6 or more substrates, all substrates can be joined simultaneously by the inventively claimed process. Alternatively, all substrates can be joined consecutively, i.e. a first and a second substrate are joined by the inventively claimed process to form another first substrate which is again joined to another second substrate by the inventively claimed process.

Accordingly, in another aspect, the presently claimed invention is directed to a method of manufacturing an article, wherein the method comprises the steps of:
H. applying the two-component polyurethane adhesive according to the claimed invention or obtained according to the method of the claimed invention onto a first substrate of the article;
I. joining a second substrate of the article to the first substrate of the article of step (H); and
J. curing the two-component polyurethane adhesive at a temperature in the range of ≥50 to ≤90° C., preferably ≥60 to ≤70° C., to form a bond between the first and the second substrate of the article.

Accordingly, in one aspect, the presently claimed invention is directed to a method of manufacturing the rotor blades of the wind turbines, wherein the method comprises the steps of:
K. applying the two-component polyurethane adhesive according to the claimed invention or obtained according to the method of the claimed invention onto a first halve of the rotor blade of the wind turbine and onto a second halve of the rotor blade of the wind turbine;
L. joining the first halve of the rotor blade of the wind turbine of step (K) to the second halve of the rotor blade of the wind turbine of step (K); and
M. curing the two-component polyurethane adhesive at a temperature in the range of ≥50 to ≤90° C., preferably ≥60 to ≤70° C., to form a bond between the first and the second halves of the rotor blades of the wind turbine.

Accordingly, in another aspect, the presently claimed invention is directed to a method of manufacturing the rotor blades of the wind turbines, wherein the method comprises the steps of:
N. applying the two-component polyurethane adhesive according to the claimed invention or obtained according to the method of the claimed invention onto a first halve of the rotor blade of the wind turbine;
O. joining a second halve to the first halve of the rotor blade of the wind turbine of step (N); and
P. curing the two-component polyurethane adhesive at a temperature in the range of ≥50 to ≤90° C., preferably ≥60 to ≤70° C., to form a bond between the first and the second halves of the rotor blades of the wind turbine.

Accordingly, in another aspect, the presently claimed invention is directed to the use of the two-component polyurethane adhesive according to the claimed invention or obtained according to the method of the claimed invention for manufacturing rotor blades of the wind turbines.

### BRIEF DESCRIPTION OF THE DRAWING

FIG. 1 illustrates comparative FT-IR-Spectrum of example 1 and reference examples 1 and 2.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)” “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

The adhesive according to the claimed invention is suitable to bond large prefabricated composite substrates, including for example but not limited to, rotor blades of wind turbines, construction of watercrafts, sandwich panels for refrigerated vehicles, containers and superstructures (caravans, trucks) or laying large area of floorings.

The two-component polyurethane adhesive according to the claimed invention has a sufficiently long open time and a short curing time. The open time and curing time have great impact on the bonding process as well as the bond strength. The “open time” defines the period during which the two-component polyurethane adhesive after being prepared by combining its reaction components, i.e. components (C1) and (C2), can be applied suitably to the composite substrates to be bonded without a significant loss of the adhesive strength or a significant increase in the viscosity. This long open time allows large composite substrates to be joined by the two-component polyurethane adhesive of the claimed invention. The two-component polyurethane adhesive according to the present invention typically have an open time of at least 45 minutes, preferably at least 50 minutes, more preferably at least 55 minutes at ambient conditions, i.e. a temperature of 23° C., and a relative humidity (RH) of 50%, the open time being determined by the rheometer according to the compression test by applying a force of 25 N and a velocity of 0.1 mm/s.

In addition to the long open time, the two-component polyurethane adhesive according to the claimed invention has a short curing time. The “curing time” refers to the time required to develop a sufficient bond strength for the bonded article to be moved without breaking the bond and the bond strength can still increase with the progression of the curing reaction. This curing time allows large prefabricated composite substrates to be joined by the two-component polyurethane adhesive of the claimed invention. The two-component polyurethane adhesive according to the claimed invention typically has a curing time in the range of ≥1 to ≤6 hours, preferably in the range of ≥2 to ≤5 hours, more preferably in the range of ≥3 to ≤4 hours at a temperature in the range of ≥60 to ≤70° C. The bond strength is determined by a single lap shear strength at the thickness of 3 mm. The two-component polyurethane adhesive according to the claimed invention develops bond strength of at least 20 MPa (as determined by lap shear strength), after 4 hours of curing at 70° C. This bond strength is advantageous to produce composite articles comprising huge prefabricated composite substrates, including for example but not limited to, rotor blades of wind turbines, construction of watercrafts, sandwich panels for refrigerated vehicles, containers and superstructures (caravans, trucks) or laying large area of floorings, particularly to produce the rotor blades for the wind turbines as this temperature interval to which the bonded substrates will be exposed to.

According to the present invention, the processing is performed at a temperature ≤30° C. and the curing is realized at a temperature ≥60° C., and, thus, to achieve the same, a catalyst with a thermal trigger ≥40° C. is used in the two-component polyurethane adhesive. The catalyst used herein is a blocked catalyst with a thermal trigger in the range of ≥40° C. to ≤60° C. to achieve the curing time in the range of ≥2 to ≤4 hours at a temperature in the range of ≥60° C. to ≤70° C. On heating to the specified temperatures, the blocking catalyst “unblocks” thereby allowing the urethane prepolymers to react and to cure within a curing time varying from a few minutes to several hours depending on the actual temperature employed. Bonds formed due to the claimed two-component polyurethane adhesive are generally tough and hard and of high strength, but is still elastic.

Typically, the two-component polyurethane adhesive according to the claimed invention has a tensile strength of at least 40 MPa, preferably at least 50 MPa, the tensile strength being determined by DIN EN ISO 527-2.

Typically, the two-component polyurethane adhesive according to the claimed invention has an e-modulus of at least 2000 MPa, preferably at least 2500 MPa, more preferably in the range of ≥2800 to ≤5000 MPa, even more preferably in the range of ≥3000 to ≤4000 MPa, the e-modulus being determined by DIN EN ISO 527-2.

Typically, the two-component polyurethane adhesive according to the claimed invention has an elongation at break of at least 2.5%, preferably of at least 3.0%, more preferably of at least 3.5%, the elongation at break being determined by ISO 527-2

Beside the improved ratio of open time/curing time, the two-component polyurethane adhesive of the invention offers a thermal stability and a high glass transition temperature which are added advantages. For bonding large prefabricated composite substrates, it is crucial to reach the specific glass transition temperature. This is very often realized by the usage of highly functional polyols, like sugar polyols, and the high crosslinking density. However, it has now been surprisingly found that the two-component polyurethane adhesives of the claimed invention have reduced the network density by using the pentaerythritol based polyol in comparison to sorbitol based polyol, but could raise the glass transition temperature.

Typically, the polyurethane adhesive of the claimed invention is a two-component composition. According to the invention, these two components which are reactive are preferably kept separate from each other and are only combined to a curable composition before being applied to the composite substrates to be bonded. The two components are the polyol component (C1) and the isocyanate component (C2) and the suitable details of the same will be described elaborately below. The polyol component (C1) further comprises thermally triggered catalyst.

Thus, the present invention relates to a two-component polyurethane adhesive comprising at least one polyol component (C1) and at least one isocyanate component (C2).

Particularly preferably, the present invention relates to a two-component polyurethane adhesive comprising at least one polyol component (C1) and at least one aromatic polyisocyanate.

The suitable details of the polyol component (C1) and the isocyanate component (C2) are provided herein as guidance to produce two-component polyurethane adhesive that will have the desired characteristic properties as described above. Those of ordinary skill in the polyurethane chemistry art will understand that a wide variety of materials are suitable for these components.

The Polyol Component (C1)

The polyol component (C1), according to the claimed invention, comprises the combination of different polyols, i.e. polyol (P1), polyol (P2) and polyol (P3).

In a preferred embodiment, the at least one polyol component (C1) comprises:
a) ≥8 to ≤30 wt. % of at least polyether polyol (P1) having a functionality of 4;
   wherein the at least one polyether polyol (P1) is represented by the following formula (I);

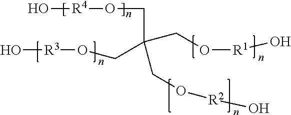

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2), and
c) ≥20 to ≤70 wt. % of at least one polyol derived from a natural oil polyol (P3),

whereby the weight percentages relate in each case to the overall amount of the polyol component (C1).

The Polyether Polyol (P1)

The polyether polyol (P1) is a pentaerythritol alkoxylate in which a hydroxy-poly(alkylene oxide) chain is connected to each of the methyl groups of neopentane. The branched polyol may also include various alkoxy groups as one of the branches, such as ethoxylate, propoxylate and butoxylate. Thus, (P1) is selected from the group consisting of pentaerythritol ethoxylate, pentaerythritol propoxylate, and pentaerythritol butoxylate. The polyether polyol (P1) has preferably a hydroxyl number in the range of ≥150 to ≤700 mg KOH/g. More preferably, the polyether polyol (P1) has a hydroxyl number in the range of ≥200 to ≤500 mg KOH/g. Even more preferably, the polyether polyol (P1) has a hydroxyl number in the range of ≥300 to ≤400 mg KOH/g.

Preferably, n each, identical or different, is a real number in the range of ≥1 to ≤4. Preferably, the sum of all n is in the range of ≥4 to ≤20. More preferably, the sum of all n is in the range of ≥4 to ≤16. Even more preferably, the sum of all n is in the range of ≥8 to ≤16.

The polyol component (C1) comprises ≥8 to ≤30 wt. % of the polyether polyol (P1), preferably ≥10 to ≤25 wt. % of the polyether polyol (P1), more preferably ≥12 to ≤22 wt. % of the polyether polyol (P1), even more preferably ≥14 to ≤20 wt. % of the polyether polyol (P1), whereby the weight percentage relates to the overall amount of the polyol component (C1).

Suitable polyols (P1) which are commercially available and may be used in the presently claimed two-component polyurethane adhesive, are for example but not limited to Polyol 4360, Polyol 4290, Polyol 4525, Polyol 4640 and Polyol R4631 which are all available from Perstorp.

The Polyol Containing the Bisphenol-A or Bisphenol-F Moiety (P2)

The at least one polyol containing an aromatic moiety (P2) may have ester or ether linkages. The polyol (P2) may be a diol or a triol or a tetraol, preferably a diol. The polyol (P2) is preferably a polyether diol containing secondary hydroxyl groups. It provides improved adhesion and exhibits resistance to hydrolysis and stability at high temperature. The polyol (P2) has preferably a hydroxyl number in the range of ≥130 to ≤340 mg KOH/g, more preferably in the range of ≥160 to ≤300 mg KOH/g, even more preferably in the range of ≥220 to ≤300 mg KOH/g.

The amount of polyol (P2) in the at least one polyol component (C1) is ≥5 to ≤20 wt. %, preferably ≥5 to ≤15 wt. %, more preferably ≥7 to ≤13 wt. %, whereby the weight percentage relates to the overall amount of the polyol component (C1).

Preferably the aromatic moiety in the polyol (P2) is a bisphenol. Bisphenols are compounds having two hydroxyphenyl groups. Preferably the bisphenol is selected from the group consisting of bisphenol A (2,2-bis(4-hydroxyphenyl)propane); bisphenol AF (1,1-bis(4-hydroxyphenyl)-1-phenylethane), bisphenol AP (1,1-bis(4-hydroxyphenyl)-1-phenylethane), bisphenol B (2,2-bis(4-hydroxyphenyl)butane), bisphenol BP (bis(4-hydroxyphenyl)diphenyl methane), bisphenol C (2,2-bis(3-methyl-4-hydroxyphenyl)propane), bisphenol E (1,1-bis(4-hydroxyphenyl)ethane), bisphenol F (bis(4-hydroxyphenyl)methane), bisphenol FL (9,9-bis(4-hydroxyphenyl)fluorene), bisphenol G (2,2-bis(4-hydroxy-3-isopropylphenyl)propane), bisphenol M (1,3-bis(2-(4-hydroxyphenyl)-2-propyl)benzene), bisphenol P (1,4-bis(2-(4-hydroxyphenyl)-2-propyl)benzene), bisphenol PH (2,2-[5,5′-bis[1,1′-(biphenyl)-2-ol]]propane), bisphenol S (bis(4-hydroxyphenyl)sulfone), bisphenol TMC (1,1-bis(4-hydroxyphenyl)-3,3,5-trimethylcyclohexane), and bisphenol Z (1,1-bis(4-hydroxyphenyl)cyclohexane).More preferably the polyol (P2) contains at least one aromatic moiety selected from the group consisting of bisphenol A and bisphenol F.

Suitable polyols (P2) which are commercially available and may be used in the presently claimed two-component polyurethane adhesive, are for example, but not limited to, Dianol® 330 from Arkema and Simusol® BPIP P and BP 11 S are product names for a bisphenol-A based polyol with a hydroxyl value of 280 mg KOH/g from Seppic.

The Polyol (P3)

The polyol (P3) is a branched polyether/polyester. It has a hydroxyl number in the range of ≥150 to ≤250 mg KOH/g, preferably the hydroxyl number is in the range of ≥160 to ≤2≥20 mg KOH/g. The at least one polyol component (C1) comprises ≥20 to ≤70 wt. %, preferably ≥25 to ≤60 wt. %, more preferably ≥30 to ≤50 wt. %, of the at least one polyol derived from a natural oil polyol (P3), whereby the weight percentage relates to the overall amount of the polyol component (C1).

The polyol (P3) comprises a natural oil polyol (NOP). In other words, the hydrophobic polyol is typically not a petroleum-based polyol, i.e., a polyol derived from petroleum products and/or petroleum by-products. In general, there are only a few naturally occurring vegetable oils that contain unreacted OH functional groups, and castor oil is typically the only commercially available NOP produced directly from a plant source that has sufficient OH functional group content to make castor oil suitable for direct use as a polyol in urethane chemistry. Most, if not all, other NOPs require chemical modification of the oils directly available from plants. The NOP is typically derived from any natural oil known in the art, typically derived from a vegetable or nut oil. Examples of suitable natural oils, for purposes of the present invention, include castor oil, and NOPs derived from soybean oil, rapeseed oil, coconut oil, peanut oil, palm oil, sunflower oil, olive oil, canola oil, etc. Employing natural oils can be useful for reducing environmental footprints.

Preferably the polyol (P3) is a polyol derived from castor oil, and in certain embodiments purified castor oil which has been purified to remove residual water. As referred to hereinafter, the term “castor oil” refers to both unpurified and purified castor oil. Those skilled in the art appreciate that castor oil inherently includes OH functional groups whereas other NOPs may require one or more additional processing steps to obtain OH functional groups. Suitable grades of castor oil, for purposes of the present invention, are commercially available from a variety of suppliers. For example, T31® Castor Oil, from Eagle Specialty Products (ESP) Inc. of St. Louis, Mo., can be employed as the hydrophobic polyol.

Castor oil is a renewable raw material and is obtained from the seeds of the castor oil plant. Castor oil is in essence a triglyceride of a fatty acid mixture comprising, based on the total weight of the fatty acid mixture, >75% by weight of ricinoleic acid, from 3 to 10% by weight of oleic acid, from 2 to 6% by weight of linoleic acid, from 1 to 4% by weight of stearic acid, from 0 to 2% by weight of palmitic acid, and also optionally small quantities, in each case less than 1% by weight, of other fatty acids such as linolenic acid, vaccenic acid, arachic acid, and eicosenoic acid.

Preferably the at least one polyol derived from a natural oil polyol (P3) is the alkoxylation product of a natural oil polyol, more preferably the alkoxylation product of castor oil. The alkoxylation is preferably achieved in that the natural oil polyol, preferably castor oil, is alkoxylated with the aid of a nucleophilic and/or basic catalyst and of at least one alkylene oxide. Preferably, the alkylene oxide is selected from the group consisting of butylene 1,2-oxide, propylene oxide and ethylene oxide. Preferably, the basic and/or nucleophilic catalyst is selected from the group consisting of alkali metal hydroxides and alkaline earth metal hydroxides, alkali metal alkoxides and alkaline earth metal alkoxides, tertiary amines, N-heterocyclic carbenes, and precursors of N-heterocyclic carbenes.

Preferably the at least one polyol derived from a natural oil polyol (P3) is natural oil polyol, in particular castor oil, that is reacted with a ketone resin.

Suitable polyols (P3) which are commercially available and may be used in the presently claimed two-component polyurethane adhesive, are for example but not limited to, SOVERMOL®, such as SOVERMOL® 750, SOVERMOL® 805, SOVERMOL® 1005, SOVERMOL® 1079, SOVERMOL® 1080, and SOVERMOL® 1102.

The at least one polyol component (C1) comprises ≥10 to ≤25 wt. % of the at least one polyether polyol (P1), ≥5 to ≤15 wt. % of the at least one polyol containing the bisphenol-A or bisphenol-F moiety (P2) and ≥25 to ≤60 wt. % of the at least one polyol derived from a natural oil polyol (P3).

It is understood that instead of a single polyol, i.e. polyol (P1), polyol (P2) and polyol (P3), also blends of the respective polyols may be used.

The Isocyanate Component (C2)

The isocyanate component (C2) is an isocyanate functional component which forms urethane linkages when reacted with the hydroxyl groups of the polyol component (C1). Typically, the isocyanate component (C2) comprises a polyisocyanate. The polyisocyanate has at least two isocyanate functional groups. The polyisocyanate may be a linear or branched, an aliphatic, a cycloaliphatic, a heterocyclic and/or an aromatic polyisocyanate. Preferably, the polyisocyanate is an aromatic polyisocyanate.

The polyisocyanate may include “prepolymer” which is a polymerization product of respective isocyanates themselves, i.e. dimers, trimers or oligomers, or a reaction product of the isocyanate component and the isocyanate reactive component to give an isocyanate functionalized prepolymer. Particularly, the polyisocyanate prepolymers may be obtained by the reaction of the polyisocyanate, i.e. the diisocyanate, with the isocyanate reactive component. The isocyanate reactive component has reactive hydrogens which react with the isocyanate groups to form the linkages. Such reactive isocyanate components have functional groups like hydroxyl groups, ester groups or amine groups.

The polyisocyanates are preferably aromatic diisocyanates. Suitable aromatic diisocyanates include, but are not limited to, 2,4-toluene diisocyanate; 2,6-toluene diisocyanate; 4,4′-methylene diphenyl diisocyanate; m-phenylene diisocyanate; 1,5-naphthalene diisocyanate; 4-chloro-1,3-phenylene diisocyanate; 2,4,6-toluylene triisocyanate, 1,3-diisopropylphenylene-2,4-diisocyanate; 1-methyl-3,5-d iethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate; 1,3,5-triisopropyl benzene-2,4,6-triisocyanate; 4.5-di-(trifluromethyl)-1,3-benzene diisocyanate; o-, m-, p-xylylene diisocyanate; 1,2-naphthylene diisocyanate, 4-chloro-1,2-naphthylene diisocyanate, 1,3-naphthylene diisocyanate, and 1,8-dinitro-2,7-naphthylene diisocyanate.

Preferably, the polyisocyanates have an isocyanate content in the range of ≥5 to ≤50%. More preferably, the polyisocyanates have an isocyanate content in the range of ≥20 to ≤35%.

Preferably, the polyisocyanate is selected from the group consisting of one or more isomers or homologues of diphenylmethane diisocyanate, polymeric diphenylmethane diisocyanate, and diphenylmethane diisocyanate based prepolymers.

Suitable diphenylmethane diisocyanate based polyisocyanate and prepolymers which are commercially available and may be used in the presently claimed two-component polyurethane adhesive, are for example but not limited to, Lupranat® M20 R from BASF SE and Desmodur® VKS 20 from Covestro AG.

Preferably, the aromatic polyisocyanate is used in combination with at least one aliphatic polyisocyanate or at least one cycloaliphatic polyisocyanates. The at least one aliphatic polyisocyanate is selected from the group consisting of tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate and 2-methyl-1,5-pentamethylene diisocyanate. The at least one s cycloaliphatic polyisocyanate is selected from the group consisting of cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocyanatomethylcyclohexane isocyanates, isocyanatoethylcyclohexane isocyanates, bis(isocyanatomethyl)cyclohexane diisocyanates, 4,4′- and 2,4′-bis(isocyanato-methyl) dicyclohexane and isophorone diisocyanate. The aliphatic and cycloaliphatic polyisocyanates can be used in the form or their isocyanurates and biurets.

Catalysts

The catalyst may be present in the polyol component (C1), the isocyanate component (C2), or in both. Preferably, the catalyst is part of the polyol component (C1). The polyol component (C1) of two-component polyurethane adhesive further comprises a catalyst which is a heat activated catalyst, i.e. a thermally triggered catalyst. The catalyst used herein is a blocked catalyst with a thermal trigger in the range of ≥40° C. to ≤60° C. and helps to cure at a time in the range of ≥2 to ≤4 hours at a temperature in the range of ≥60° C. to ≤70° C. On heating to the specified temperatures, the blocking catalyst “unblocks” allowing the urethane prepolymers to react and to cure with a curing time varying from a few minutes to several hours depending on the actual temperature employed. Preferably, the heat activated catalyst is a cyclic tertiary amine. More preferably, the heat activated catalyst includes, but is not limited to, the group consisting of 1,8-diaza-bicyclo[5.4.0]undec-7-ene, 1,5-diaza-bicyclo[4.3.0]non-5-ene, 1,4-diazabicyclo[2.2.2]-octane, N-cetyl-N,N-dimethylamine and dimethylcyclohexylamine. Even more preferably, such a heat activated catalyst is a blocked catalyst. Thus, in a preferred embodiment of the invention, the catalyst is blocked 1,8-diaza-bicyclo[5.4.0]undec-7-ene.

Preferably, the polyol component (C1) comprises ≥0.05 to ≤1.0 wt. %, more preferably ≥0.05 to ≤0.5 wt. %, even more preferably ≥0.1 to ≤0.5 wt. %, of at least one heat activated catalyst, whereby the weight percentage relates to the overall amount of the polyol component (C1).

Suitable blocked heat activated catalyst which are commercially available, include for example Polycat® SA-1/10 which is available from EVONIK, Polycat SA 2 LE, Polycat SA 4 and Polycat SA, Toyocat DB 30, Toyocat DB 41, Toyocat DB 42 or Toyocat DB 60.

Additives

The two-component polyurethane adhesive further comprises at least one additive or auxiliary component. Preferably, the additive or auxiliary component is added to the polyol component (C1). Preferably, it is part of the polyol component (C1). The additive or auxiliary component is selected from the group consisting of chain extender, water scavengers, fillers, deaerating agents, thixotropic agents, antioxidants, dyes, desiccants, resins, plasticizers, wetting agents and pigments. The additive may be used to modify the properties of the adhesive, for example, to control the wetting behavior, viscosity, storage life, sagging, moisture resistance, etc. The wetting agent may be used to improve the spreadability of the adhesive on the components to be bonded. The deaerating agents may be added to reduce the formation of bubbles or to reduce sagging while bonding the components. The additives used herein are known and used in the polyurethane chemistry art for producing two-component polyurethane adhesives.

Preferably, the two-component polyurethane adhesive comprises ≥0 to ≤40 wt. %, more preferably ≥10 to ≤40 wt. %, even more preferably ≥15 to ≤40 wt. %, most preferably ≥20 to ≤40 wt. %, of at least one additive or auxiliary component, whereby the weight percentage relates to the overall amount of the polyol component (C1).

Preferred chain extender include aromatic amines such as benzene amine.

A water scavenger is a material which is capable of adsorbing water. Preferred water scavengers are zeolite and/or calcium oxide.

Preferred fillers are selected from the group consisting of aluminium oxide, aluminium hydroxide, quartz flour, quartz sand, barites, calcium carbonate, chalk, dolomite or talcum. wherein the fillers are preferably added in amounts of ≥15 to ≤30 wt. %, more preferably ≥20 to ≤30 wt. % whereby the weight percentage relates to the overall amount of the polyol component (C1).

Preferred thixotropic agents are selected from the group consisting of urea compounds, polyamide waxes, bentonites or pyrogenic silica and fumed silica.

In a more preferred embodiment, the at least one polyol component (C1) comprises:
a) ≥8 to ≤30 wt. % of at least polyether polyol (P1) having a functionality of 4;
   wherein the at least one polyether polyol (P1) is represented by the following formula (I);

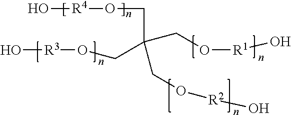

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2), and
c) ≥20 to ≤70 wt. % of at least one polyol derived from a natural oil polyol (P3),
d) ≥0.05 to ≤1.0 wt. % of at least one heat activated catalyst, and
e) ≥5 to ≤40 wt. % of at least additive or auxiliary component additive or auxiliary component selected from the group consisting of chain extender, water scavengers, fillers, deaerating agents, thixotropic agents, antioxidants, dyes, desiccants, resins, plasticizers, wetting agents and pigments,

whereby the weight percentages relate in each case to the overall amount of the polyol component (C1) and the sum of weight percentages of all components a), b), c), d) and e) adds up to 100.

Deactivators

The isocyanate component (C2) has impurities which may lead to accelerated reactivity . To adjust the reactivity, the two-component polyurethane adhesive of the claimed invention comprises at least one deactivator. The at least one deactivator is selected from the group consisting of an aliphatic and an aromatic acid chloride selected from the group consisting of acetyl chloride, benzoyl chloride, benzene sulfonyl chloride, oxalyl chloride, adipyl chloride, sebacyl chloride and carbonyl chloride; an inorganic acid selected from the group consisting of perchloric acid; an organic acid selected from the group consisting of trifluoromethane sulfonic acid and trifluoroacetic acid; and a chloroformate selected from the group consisting of methyl chloroformate, ethyl chloroformate, isopropyl chloroformate, n-butyl chloroformate, sec-butyl chloroformate and diethylene glycol bischloroformate. Preferably, the deactivator used is diethylene glycol bischloroformate.

In a preferred embodiment, the two-component polyurethane adhesive comprises:
i. at least one polyol component (C1) comprising:
   a) ≥8 to ≤30 wt. % of at least polyether polyol (P1) having a functionality of 4;
      wherein the at least one polyether polyol (P1) is represented by the following formula (I);

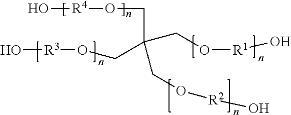

wherein
R ¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2) and
c) ≥20 to ≤70 wt. % of at least one polyol derived from a natural oil polyol (P3), whereby the weight percentages relate in each case to the overall amount of the polyol component (C1);
   and
ii. at least one aromatic polyisocyanate;

whereby the two-component polyurethane adhesive exhibits a glass transition temperature of ≥70° C., the glass transition temperature being determined by a DSC measurement according to DIN 11357 at a heating rate of 20° C./min.

In another preferred embodiment, the two-component polyurethane adhesive comprises:
i. at least one polyol component (C1) comprising:
   a) ≥8 to ≤30 wt. % of at least polyether polyol (P1) having a functionality of 4;
      wherein the at least one polyether polyol (P1) is represented by the following formula (I);

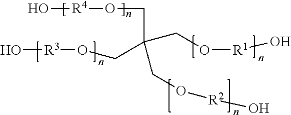

wherein R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2),
c) ≥20 to ≤70 wt, % of at least one polyol derived from a natural oil polyol (P3), and
d) ≥0.05 to ≤1.0 wt. % of at least one heat activated catalyst,

whereby the weight percentages relate in each case to the overall amount of the polyol component (C1);

and
ii. at least one aromatic polyisocyanate;

whereby the two-component polyurethane adhesive exhibits a glass transition temperature of ≥70° C., the glass transition temperature being determined by a DSC measurement according to DIN 11357 at a heating rate of 20° C./min.

In another preferred embodiment, the two-component polyurethane adhesive comprises:
i. at least one polyol component (C1) comprising:
   a) ≥8 to ≤30 wt. % of at least polyether polyol (P1) having a functionality of 4;
   wherein the at least one polyether polyol (P1) is represented by the following formula (I);

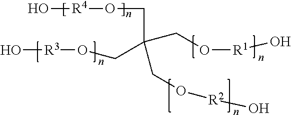

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2),
c) ≥20 to ≤70 wt. % of at least one polyol derived from a natural oil polyol (P3),
d) ≥0.05 to ≤1.0 wt. % of at least one heat activated catalyst, and
e) ≥5 to ≤40 wt. % of at least additive or auxiliary component additive or auxiliary component selected from the group consisting of chain extender, water scavengers, fillers, deaerating agents, thixotropic agents, antioxidants, dyes, desiccants, resins, plasticizers, wetting agents and pigments,
whereby the weight percentages relate in each case to the overall amount of the polyol component (C1);
and
ii. at least one aromatic polyisocyanate;

whereby the two-component polyurethane adhesive exhibits a glass transition temperature of ≥70° C., the glass transition temperature being determined by a DSC measurement according to DIN 11357 at a heating rate of 20° C./min.

A method for producing the two-component polyurethane adhesive according to the claimed invention comprises the steps of
A. providing at least one polyol component (C1) comprising
   a) ≥8 to ≤30 wt. % of at least polyether polyol (P1) having a functionality of 4;
      wherein the at least one polyether polyol (P1) is represented by the following formula (I);

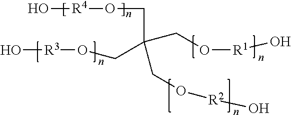

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂—, and —CH₂—CH₂—CH₂— and
n each, identical or different, is a real number in the range of ≥1 to ≤6,
b) ≥5 to ≤20 wt. % of at least one polyol containing an aromatic moiety (P2), and
c) ≥20 to ≤70 wt. % of at least one polyol derived from a natural oil polyol (P3),
   whereby the weight percentages relate in each case to the overall amount of the polyol component (C1);
B. providing at least one isocyanate component (C2);
C. adding at least one deactivator to the at least one isocyanate component (C2) of step (B); and
D. mixing the at least one polyol component (C1) of step (A) with the at least one isocyanate component (C2) of step (C) at an index in the range of ≥102 to ≤108;

to obtain the two-component polyurethane adhesive.

The polyol component (C1) may be provided by mixing the at least one polyol (P1), the at least one polyol (P2) and the at least one polyol derived from a natural oil polyol (P3). Further, the method comprises the addition of at least one additive or auxiliary component to the polyol component (C1). Typically, ≥10 to ≤40 wt. % of the at least one additive or auxiliary component, whereby the weight percentage relates to the overall amount of the polyol component (C1), is added to the component (C1).

Essentially, during the production of the two-component polyurethane adhesive, the components (C1) and (C2) including all sub-components like (P1), (P2), (P3), the additive or auxiliary component, the catalyst and the deactivator are reasonably free from water or moisture, and that during and after the method of production of the adhesive and storage thereafter, reasonably avoid or eliminate any contact of the moisture. This can be achieved by the use of additives or physical or chemical drying of the components or by working under an inert gas atmosphere, such as an atmosphere of nitrogen. The components (C1) and (C2) are kept separately from each other and are only combined prior to the use of such two-component polyurethane adhesive. The components (C1) and (C2) may be separately packed or may be packed in two chambers which are separated from each other, preferably, the packaging is air tight or moisture tight. The packaging may also be performed in the inert atmosphere of nitrogen.

The mixing of the components (C1) and (C2) is performed by using any conventional means including static mixer or dynamic mixer to ensure homogeneous mixing as much as possible to eliminate any adverse impact on the characteristic properties of the cured two-component polyurethane adhesive of the claimed invention.

In a preferred embodiment, the method for producing the two-component polyurethane adhesive according to the claimed invention comprises the steps of
A. providing at least one polyol component (C1) comprising
   a) ≥8 to ≤30 wt. % of at least polyether polyol (P1) having a functionality of 4;
      wherein the at least one polyether polyol (P1) is represented by the following formula (I);

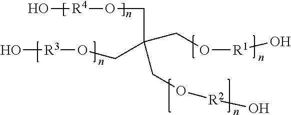

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂—, and —CH₂—CH₂—CH₂— and
n each, identical or different, is a real number in the range of ≥1 to ≤6,
b) ≥5 to ≤20 wt. % of at least one polyol containing an aromatic moiety (P2), and
c) ≥20 to ≤70 wt. % of at least one polyol derived from a natural oil polyol (P3),
   whereby the weight percentages relate in each case to the overall amount of the polyol component (C1);
B. providing at least one aromatic polyisocyanate;
C. adding at least one deactivator to the at least one aromatic polyisocyanate of step (B); and
D. mixing the at least one polyol component (C1) of step (A) with the at least one aromatic polyisocyanate of step (C) at an index in the range of ≥102 to ≤108;

to obtain the two-component polyurethane adhesive.

In another preferred embodiment, the method for producing the two-component polyurethane adhesive according to the claimed invention comprises the steps of
A. providing at least one polyol component (C1) comprising
   a) ≥8 to ≤30 wt. % of at least polyether polyol (P1) having a functionality of 4;
      wherein the at least one polyether polyol (P1) is represented by the following formula (I),

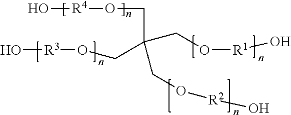

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂—, and —CH₂—CH₂—CH₂— and
n each, identical or different, is a real number in the range of ≥1 to ≤6,
b) ≥5 to ≤20 wt. % of at least one polyol containing an aromatic moiety (P2),
c) ≥20 to ≤70 wt. % of at least one polyol derived from a natural oil polyol (P3), and
d) ≥0.05 to ≤1.0 wt. % of at least one heat activated catalyst,
   whereby the weight percentages relate in each case to the overall amount of the polyol component (C1);
B. providing at least one aromatic polyisocyanate;
C. adding at least one deactivator to the at least one aromatic polyisocyanate of step (B); and
D. mixing the at least one polyol component (C1) of step (A) with the at least one aromatic polyisocyanate of step (C) at an index in the range of ≥102 to ≤108;

to obtain the two-component polyurethane adhesive.

In another preferred embodiment, the method for producing the two-component polyurethane adhesive according to the claimed invention comprises the steps of
A. providing at least one polyol component (C1) comprising
   a) ≥8 to ≤30 wt. % of at least polyether polyol (P1) having a functionality of 4;
      wherein the at least one polyether polyol (P1) is represented by the following formula (I),

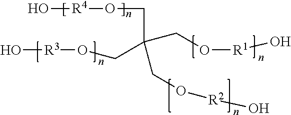

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂—, and —CH₂—CH₂—CH₂— and
n each, identical or different, is a real number in the range of ≥1 to ≤6,
b) ≥5 to ≤20 wt. % of at least one polyol containing an aromatic moiety (P2),
c) ≥20 to ≤70 wt. % of at least one polyol derived from a natural oil polyol (P3),
d) ≥0.05 to ≤1.0 wt. % of at least one heat activated catalyst, and
e) ≥5 to ≤40 wt. % of at least additive or auxiliary component additive or auxiliary component selected from the group consisting of chain extender, water scavengers, fillers, deaerating agents, thixotropic agents, antioxidants, dyes, desiccants, resins, plasticizers, wetting agents and pigments,
   whereby the weight percentages relate in each case to the overall amount of the polyol component (C1);
B. providing at least one aromatic polyisocyanate;
C. adding at least one deactivator to the at least one aromatic polyisocyanate of step (B); and
D. mixing the at least one polyol component (C1) of step (A) with the at least one aromatic polyisocyanate of step (C) at an index in the range of ≥102 to ≤108;

to obtain the two-component polyurethane adhesive.

An article comprises at least one first substrate and at least one second substrate, wherein the two-component polyurethane adhesive according to the claimed invention or obtained according to the method of the claimed invention is present in-between the first substrate and the second substrate of the article and forms an adhesive bond between them. An article preferably comprises more than two substrates. In case an article comprises more than two substrates, i.e. 3, 4, 5, 6 or more substrates, all substrates can be joined simultaneously by the inventively claimed process. Alternatively, all substrates can be joined consecutively, i.e. a first and a second substrate are joined by the inventively claimed process to form another first substrate which is again joined to another second substrate by the inventively claimed process.

The two-component polyurethane adhesive after mixing the components (C1) and (C2) is applied to the substrates to be bonded within the open time. Typically, two substrates are present which need to be bonded. The substrates are not limited. They can be, for example, a metal, a metal alloy, a plastic, a lignocellulosic material such as wood, cardboard or paper, a glass, a ceramic, various types of composites, or other materials. The substrates to be bonded are preferably made of a metal, a plastic, a glass or a ceramic. The substrates to be bonded are either identical or different. After applying the adhesive of the claimed invention to the substrates within the open time and joining them positively, curing of the polyurethane composition occurs at specified temperatures.

Typical examples of application of the two-component polyurethane adhesive of the claimed invention can be found in rotor blades of wind turbines, construction of watercrafts, sandwich panels for refrigerated vehicles, containers and superstructures (caravans, trucks) or laying large area of floorings. Here, the cured adhesive becomes a part of bonded substrates imparting improved mechanical properties as specified above.

In a preferred embodiment, the present invention is directed to the use of two-component polyurethane adhesive of the invention for manufacturing rotor blades of wind turbines.

Furthermore, the inventive two-component adhesive shows the improved open time to cure time ratio along with the excellent bond strength of at least 20 MPa (as determined by lap shear strength), the high glass transition temperature of ≥70° C., and the improved mechanical properties such as the tensile strength of at least 50 MPa, e-modulus of at least 2500 MPa, and the elongation at break of at least 3.5%.

The two-component polyurethane adhesive according to the present invention shows at least one of the following advantages:
1. It has sufficiently long open time, i.e. an open time ≥45 min.
2. It shows and sufficiently less curing time, i.e. a curing time ≥70° C. for two hours.
3. It has excellent mechanical properties, i.e. excellent bonding strength.
4. It is still elastic.
5. It shows a glass transition temperature ≥65° C., preferably ≤70° C.
6. It exhibits a processing temperature ≥30° C. and a curing temperature ≤60° C.

In the following, there is provided a list of embodiments to further illustrate the present disclosure without intending to limit the disclosure to the specific embodiments listed below.
1. A two-component polyurethane adhesive comprising:
   i. at least one polyol component (C1) comprising:
   a) ≥8 to ≤30 wt. % of at least polyether polyol (P1) having a functionality of 4;
   wherein the at least one polyether polyol (P1) is represented by the following formula (I);

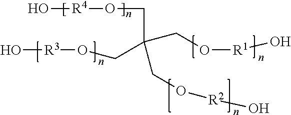

wherein R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2) and
c) ≥20 to ≤70 wt. % of at least one polyol derived from a natural oil polyol (P3),
   whereby the weight percentages relate in each case to the overall amount of the polyol component (C1); and
ii. at least one isocyanate component (C2);
whereby the two-component polyurethane adhesive exhibits a glass transition temperature of ≥70° C., the glass transition temperature being determined by a DSC measurement according to DIN 11357 at a heating rate of 20° C./min.
2. The two-component polyurethane adhesive according to embodiment 1, wherein R¹, R², R³ and R⁴ each, identical or different, are selected from the group consisting of —CH₂—CH₂— and —CH(CH₃)—CH₂—.
3. The two-component polyurethane adhesive according to embodiment 1 or 2, wherein n each, identical or different, is a real number in the range of ≥1 to ≤4.
4. The two-component polyurethane adhesive according to one or more of embodiments 1 to 3, wherein the at least one polyether polyol (P1) has a hydroxyl number in the range of ≥150 to ≤700 mg KOH/g.
5. The two-component polyurethane adhesive according to one or more of embodiments 1 to 4, wherein the at least one polyol component (C1) comprises ≥10 to ≤25 wt. % of the at least one polyether polyol (P1), whereby the weight percentage relates to the overall amount of the polyol component (C1).
6. The two-component polyurethane adhesive according to one or more of embodiments 1 to 5, wherein the at least one polyol containing an aromatic moiety (P2) has a hydroxyl number in the range of ≥130 to ≤340 mg KOH/g.
7. The two-component polyurethane adhesive according to one or more of embodiments 1 to 6, wherein the at least one polyol component (C1) comprises ≥5 to ≤15 wt. % of the at least one polyol containing an aromatic moiety (P2), whereby the weight percentage relates to the overall amount of the polyol component (C1).
8. The two-component polyurethane adhesive according to one or more of embodiments 1 to 7, wherein the aromatic moiety is bisphenol.
9. The two-component polyurethane adhesive according to one or more of embodiments 1 to 8, wherein the at least one polyol derived from a natural oil polyol (P3) has a hydroxyl number in the range of ≥150 to ≤250 mg KOH/g.
10. The two-component polyurethane adhesive according to one or more of embodiments 1 to 9, wherein the at least one polyol component (C1) comprises ≥25 to ≤60 wt. % of the at least one polyol derived from a natural oil polyol (P3), whereby the weight percentage relates to the overall amount of the polyol component (C1).
11. The two-component polyurethane adhesive according to one or more of embodiments 1 to 10, wherein the natural oil polyol is selected from the group consisting of castor oil and natural oil polyols derived from soybean oil, rapeseed oil, coconut oil, peanut oil, palm oil, sunflower oil, olive oil or canola oil.
12. The two-component polyurethane adhesive according to one or more of embodiments 1 to 11, wherein the at least one polyol derived from a natural oil polyol (P3) is the alkoxylation product of a natural oil polyol.
13. The two-component polyurethane adhesive according to one or more of embodiments 1 to 12, wherein the natural oil polyol is castor oil.
14. The two-component polyurethane adhesive according to one or more of embodiments 1 to 13, wherein the at least one polyol component (C1) comprises ≥10 to ≤25 wt. % of the at least one polyether polyol (P1), ≥5 to ≤15 wt. % of the at least one polyol containing an aromatic moiety (P2) ≥25 to ≤60 wt. % of the at least one polyol derived from a natural oil polyol (P3),and ≥10 to ≤40 wt. % of at least one additive selected from the group consisting of chain extenders, water scavengers, fillers, deaerating agents, thixotropic agents, antioxidants, dyes, catalysts, desiccants, resins, plasticizers, wetting agents and pigments, whereby the weight percentages relate to the overall amount of the polyol component (C1)
15. The two-component polyurethane adhesive according to one or more of embodiments 1 to 14, wherein the at least one isocyanate component (C2) is an aromatic polyisocyanate.
16. The two-component polyurethane adhesive according to embodiment 11, wherein the aromatic polyisocyanate further comprises at least one deactivator.
17. The two-component polyurethane adhesive according to embodiment 16, wherein the at least one deactivator is selected from the group consisting of an aliphatic and an aromatic acid chloride selected from the group consisting of acetyl chloride, benzoyl chloride, benzene sulfonyl chloride, oxalyl chloride, adipyl chloride, sebacyl chloride and carbonyl chloride; an inorganic acid selected from the group consisting of perchloric acid; an organic acid selected from the group consisting of trifluoromethane sulfonic acid and trifluoroacetic acid; and a chloroformate selected from the group consisting of methyl chloroformate, ethyl chloroformate, isopropyl chloroformate, n-butyl chloroformate, sec-butyl chloroformate and diethylene glycol bischloroformate.
18. The two-component polyurethane adhesive according to embodiment 15, wherein the aromatic polyisocyanate is selected from the group consisting of polymeric methylene diphenyl diisocyanate and polymeric toluene diisocyanate.
19. The two-component polyurethane adhesive according to one or more of embodiments 1 to 18, wherein the two-component polyurethane adhesive comprises ≥0.05 to ≤1.0 wt. % of at least one heat activated catalyst, whereby the weight percentage relates to the overall amount of the polyol component (C1).
20. The two-component polyurethane adhesive according to embodiment 19, wherein the at least one heat activated catalyst is a cyclic tertiary amine.
21. The two-component polyurethane adhesive according to embodiment 20, wherein the cyclic tertiary amine is selected from the group consisting of 1,8-diaza-bicyclo[5.4.0]undec-7-ene, 1,5-diaza-bicyclo[4.3.0]non-5-ene, 1,4-diazabicyclo[2.2.2]octane, N-cetyl-N,N-dimethylamine and dimethylcyclohexylamine.
22. The two component polyurethane adhesive according to embodiment 20, wherein the cyclic tertiary amine is blocked 1,8-diaza-bicyclo[5.4.0]undec-7-ene.
23. The two-component polyurethane adhesive according to one or more of embodiments 1 to 22, wherein the two-component polyurethane adhesive comprises ≥10 to ≤40 wt. % of at least one additive, whereby the weight percentage relates to the overall amount of the polyol component (C1).
24. The two-component polyurethane adhesive according to embodiment 23, wherein the at least one additive is selected from the group consisting of chain extenders, water scavengers, fillers, deaerating agents, thixotropic agents, antioxidants, dyes, catalysts, desiccants, resins, plasticizers, wetting agents and pigments.
25. The two-component polyurethane adhesive according to one or more of embodiments 1 to 24, wherein the glass transition temperature in the range of ≥70 to ≤90° C., the glass transition temperature being determined by the DSC measurement according to DIN 11357 at the heating rate of 20° C./min.
26. A method for producing the two-component polyurethane adhesive according to one or more of embodiments 1 to 25, wherein the method comprises the steps of:
   A. providing at least one polyol component (C1) comprising:
      a) ≥8 to ≤30 wt. % of at least polyether polyol (P1) having a functionality of 4;
         wherein the at least one polyether polyol (P1) is represented by the following formula (I);

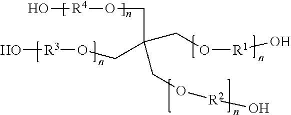

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and n each, identical or different, is a real number in the range of ≥1 to ≤6,
b) ≥5 to ≤20 wt. % of at least one polyol containing an aromatic moiety (P2), and
c) ≥20 to ≤70 wt.-% of at least one polyol derived from a natural oil polyol (P3),
   whereby the weight percentages relate in each case to the overall amount of the polyol component (C1);
B. providing at least one isocyanate component (C2);
C. adding at least one deactivator to the at least one isocyanate component (C2) of step (B); and
D. mixing the at least one polyol component (C1) of step (A) with the at least one isocyanate component (C2) of step (C) at an index in the range of ≥102 to ≤108;
to obtain the two-component polyurethane adhesive exhibiting a glass transition temperature of ≥70° C., the glass transition temperature being determined by a DSC measurement according to DIN 11357 at a heating rate of 20° C./min.
27. The method according to embodiment 26, wherein the index is in the range of ≥102 to ≤106.
28. An article comprising at least one first substrate and one second substrate wherein the two-component adhesive according to one or more of embodiments 1 to 25 or obtained according to embodiment 26 or 27 is present in-between the first substrate and the second substrate of the article and forms an adhesive bond between them.
29. The article according to embodiment 28, wherein the article is a rotor blade for the wind turbines and the first substrate and the second substrate are the first and the second halves of the rotor blades, respectively.
30. A method of manufacturing the article according to embodiment 28 or 29 comprising the steps of:
   E. applying the two-component polyurethane adhesive according to one or more of embodiments 1 to 25 or obtained according to embodiment 26 or 27 onto a first substrate of the article and onto a second substrate of the article;
   F. joining the first substrate of the article of step (E) and the second substrate of the article of step (E); and
   G. curing the two-component polyurethane adhesive at a temperature in the range of ≥60 to ≤90° C. to form a bond between the first and second substrate of the article.
31. A method of manufacturing the rotor blades of the wind turbines comprising the steps of:
   H. applying the two-component polyurethane adhesive according to one or more of embodiments 1 to 25 or obtained according to embodiment 26 or 27 onto a first halve of the rotor blade of the wind turbine and onto a second halve of the rotor blade of the wind turbine;
   I. joining the second halve of the rotor blade of the wind turbine of step (H) to the first halve of the rotor blade of the wind turbine of step (H); and
   J. curing the two-component polyurethane adhesive at temperature in the range of ≥60 to ≤90° C. to form a bond between the first and second halves of the rotor blades of the wind turbine.
32. A use of the two-component polyurethane adhesive according to one or more of embodiments 1 to 25 or obtained according to embodiment 26 or 27 for manufacturing rotor blades of wind turbines.
33. A two-component polyurethane adhesive comprising:
   i. at least one polyol component (C1) comprising:
   a) ≥8 to ≤30 wt. % of at least polyether polyol (P1) having a functionality of 4;
   wherein the at least one polyether polyol (P1) is represented by the following formula (I);

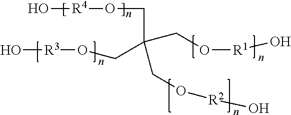

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in the range of ≥1 to ≤6,
b) ≥5 to ≤20 wt. % of at least one polyol containing an aromatic moiety (P2) and
c) ≥20 to ≤70 wt. % of at least one polyol derived from a natural oil polyol (P3),
whereby the weight percentages relate in each case to the overall amount of the polyol component (C1);
and
ii. at least one aromatic polyisocyanate;
whereby the two-component polyurethane adhesive exhibits a glass transition temperature of ≥70° C., the glass transition temperature being determined by a DSC measurement according to DIN 11357 at a heating rate of 20° C./min.
34. The two-component polyurethane adhesive according to embodiment 33, wherein R¹, R², R³ and R⁴ each, identical or different, are selected from the group consisting of —CH₂—CH₂— and —CH(CH₃)—CH₂—.
35. The two-component polyurethane adhesive according to embodiment 33 or 34, wherein n each, identical or different, is a real number in the range of ≥1 to ≤4.
36. The two-component polyurethane adhesive according to one or more of embodiments 33 to 35, wherein the at least one polyether polyol (P1) has a hydroxyl number in the range of ≥150 to ≤700 mg KOH/g.
37. The two-component polyurethane adhesive according to one or more of embodiments 33 to 36, wherein the at least one polyol component (C1) comprises ≥10 to ≤25 wt. % of the at least one polyether polyol (P1), whereby the weight percentage relates to the overall amount of the polyol component (C1).
38. The two-component polyurethane adhesive according to one or more of embodiments 33 to 37, wherein the at least one polyol containing an aromatic moiety (P2) has a hydroxyl number in the range of ≥130 to ≤340 mg KOH/g.
39. The two-component polyurethane adhesive according to one or more of embodiments 33 to 38, wherein the at least one polyol component (C1) comprises ≥5 to ≤15 wt. % of the at least one polyol containing an aromatic moiety (P2), whereby the weight percentage relates to the overall amount of the polyol component (C1).
40. The two-component polyurethane adhesive according to one or more of embodiments 33 to 39, wherein the aromatic moiety is bisphenol.
41. The two-component polyurethane adhesive according to one or more of embodiments 33 to 40, wherein the at least one polyol derived from a natural oil polyol (P3) has a hydroxyl number in the range of ≥150 to ≤250 mg KOH/g.
42. The two-component polyurethane adhesive according to one or more of embodiments 33 to 41, wherein the at least one polyol component (C1) comprises ≥25 to ≤60 wt. % of the at least one polyol derived from a natural oil polyol (P3), whereby the weight percentage relates to the overall amount of the polyol component (C1).
43. The two-component polyurethane adhesive according to one or more of embodiments 33 to 42, wherein the natural oil polyol is selected from the group consisting of castor oil and natural oil polyols derived from soybean oil, rapeseed oil, coconut oil, peanut oil, palm oil, sunflower oil, olive oil or canola oil.
44. The two-component polyurethane adhesive according to one or more of embodiments 33 to 43, wherein the at least one polyol derived from a natural oil polyol (P3) is the alkoxylation product of a natural oil polyol.
45. The two-component polyurethane adhesive according to one or more of embodiments 33 to 44, wherein the natural oil polyol is castor oil.
46. The two-component polyurethane adhesive according to one or more of embodiments 33 to 45, wherein the at least one polyol component (C1) comprises ≥10 to ≤25 wt. % of the at least one polyether polyol (P1), ≥5 to ≤15 wt. % of the at least one polyol containing an aromatic moiety (P2) ≥25 to ≤60 wt. % of the at least one polyol derived from a natural oil polyol (P3), and ≥10 to ≤40 wt. % of at least one additive selected from the group consisting of chain extenders, water scavengers, fillers, deaerating agents, thixotropic agents, antioxidants, dyes, catalysts, desiccants, resins, plasticizers, wetting agents and pigments, whereby the weight percentages relate to the overall amount of the polyol component (C1)
47. The two-component polyurethane adhesive according to one or more of embodiments 33 to 46, wherein the aromatic polyisocyanate further comprises at least one deactivator.
48. The two-component polyurethane adhesive according to embodiment 47, wherein the at least one deactivator is selected from the group consisting of an aliphatic and an aromatic acid chloride selected from the group consisting of acetyl chloride, benzoyl chloride, benzene sulfonyl chloride, oxalyl chloride, adipyl chloride, sebacyl chloride and carbonyl chloride; an inorganic acid selected from the group consisting of perchloric acid; an organic acid selected from the group consisting of trifluoromethane sulfonic acid and trifluoroacetic acid; and a chloroformate selected from the group consisting of methyl chloroformate, ethyl chloroformate, isopropyl chloroformate, n-butyl chloroformate, sec-butyl chloroformate and diethylene glycol bischloroformate.
49. The two-component polyurethane adhesive according to one or more of embodiments 33 to 48, wherein the aromatic polyisocyanate is selected from the group consisting of polymeric methylene diphenyl diisocyanate and polymeric toluene diisocyanate.
50. The two-component polyurethane adhesive according to one or more of embodiments 33 to 49, wherein the two-component adhesive comprises ≥0.05 to ≤1.0 wt. % of at least one heat activated catalyst, whereby the weight percentage relates to the overall amount of the polyol component (C1).
51. The two-component polyurethane adhesive according to embodiment 50, wherein the at least one heat activated catalyst is a cyclic tertiary amine.
52. The two-component polyurethane adhesive according to embodiment 51, wherein the cyclic tertiary amine is selected from the group consisting of 1,8-diaza-bicyclo[5.4.0]undec-7-ene, 1,5-diaza-bicyclo[4.3.0]non-5-ene, 1,4-diazabicyclo[2.2.2]octane, N-cetyl-N,N-dimethylamine and dimethylcyclohexylamine.
53. The two component polyurethane adhesive according to embodiment 52, wherein the cyclic tertiary amine is blocked 1,8-diaza-bicyclo[5.4.0]undec-7-ene.
54. The two-component polyurethane adhesive according to one or more of embodiments 33 to 53, wherein the two-component polyurethane adhesive comprises ≥10 to ≤40 wt. % of at least one additive, whereby the weight percentage relates to the overall amount of the polyol component (C1).
55. The two-component polyurethane adhesive according to embodiment 54, wherein the at least one additive is selected from the group consisting of chain extenders, water scavengers, fillers, deaerating agents, thixotropic agents, antioxidants, dyes, catalysts, desiccants, resins, plasticizers, wetting agents and pigments.
56. The two-component polyurethane adhesive according to one or more of embodiments 33 to 55, wherein the glass transition temperature in the range of ≥70 to ≤90° C., the glass transition temperature being determined by the DSC measurement according to DIN 11357 at the heating rate of 20° C./min.
57. A method for producing the two-component polyurethane adhesive according to one or more of embodiments 33 to 56, wherein the method comprises the steps of:
   A. providing at least one polyol component (C1) comprising:
      a) ≥8 to ≤30 wt. % of at least polyether polyol (P1) having a functionality of 4;
         wherein the at least one polyether polyol (P1) is represented by the following formula (I);

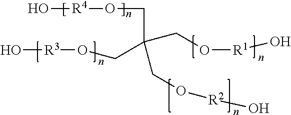

wherein
R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and n each, identical or different, is a real number in the range of ≥1 to ≤6,
b) ≥5 to ≤20 wt. % of at least one polyol containing an aromatic moiety (P2), and
c) ≥20 to ≤70 wt.-% of at least one polyol derived from a natural oil polyol (P3),
   whereby the weight percentages relate in each case to the overall amount of the polyol component (C1);
B. providing at least one aromatic polyisocyanate;
C. adding at least one deactivator to the at least one aromatic polyisocyanate of step (B); and
E. mixing the at least one polyol component (C1) of step (A) with the at least one aromatic polyisocyanate of step (C) at an index in the range of ≥102 to ≤108;
to obtain the two-component polyurethane adhesive exhibiting a glass transition temperature of ≥70° C., the glass transition temperature being determined by a DSC measurement according to DIN 11357 at a heating rate of 20° C./min.
58. The method according to embodiment 57, wherein the index is in the range of ≥102 to ≤106.
59. An article comprising at least one first substrate and one second substrate wherein the two-component adhesive according to one or more of embodiments 33 to 56 or obtained according to embodiment 57 or 58 is present in-between the first substrate and the second substrate of the article and forms an adhesive bond between them.
60. The article according to embodiment 59, wherein the article is a rotor blade for the wind turbines and the first substrate and the second substrate are the first and the second halves of the rotor blades, respectively.
61. A method of manufacturing the article according to embodiment 59 or 60 comprising the steps of:
   E. applying the two-component polyurethane adhesive according to one or more of embodiments 1 to 24 or obtained according to embodiment 25 or 26 onto a first substrate of the article and onto a second substrate of the article;
   F. joining the first substrate of the article of step (E) and the second substrate of the article of step (E); and
   G. curing the two-component polyurethane adhesive at a temperature in the range of ≥60 to ≤90° C. to form a bond between the first and second substrate of the article.
62. A method of manufacturing the rotor blades of the wind turbines comprising the steps of:
   H. applying the two-component polyurethane adhesive according to one or more of embodiments 33 to 56 or obtained according to embodiment 57 or 58 onto a first halve of the rotor blade of the wind turbine and onto a second halve of the rotor blade of the wind turbine;
   I. joining the second halve of the rotor blade of the wind turbine of step (H) to the first halve of the rotor blade of the wind turbine of step (H); and
   J. curing the two-component polyurethane adhesive at temperature in the range of ≥60 to ≤90° C. to form a bond between the first and second halves of the rotor blades of the wind turbine.
63. A use of the two-component polyurethane adhesive according to one or more of embodiments 33 to 56 or obtained according to embodiment 57 or 58 for manufacturing rotor blades of wind turbines.

The present invention is illustrated by the non-restrictive examples which are as follows:

Chemicals
1. Polyol 4360 supplied by Perstorp, CAS-No. 9051-49-4, pentaerythritol-based polyol that is alkoxylated with propylene oxide, hydroxyl number 360 mg KOH/g, available from Perstorp
2. Dianol® 330, Bisphenol A-based polyol that is alkoxylated with propylene oxide, hydroxyl number 280 mg KOH/g, available from Arkema
3. Sovermol® 1079, alkoxylated castor oil-based polyol, hydroxyl number 170 mg KOH/g, available from BASF SE
4. Lonzacure® M-DEA, available from Lonza
5. Chalk Filler, available from Omya
6. Fumed Silica, available from Wacker Chemie or EVONIK
7. Dispersing Agent, such as EFKA® available from BASF SE
8. Zeolite
9. Polycat® SA-1/10, 1,8-diaza-bicyclo[5.4.0]undec-7-ene, available from EVONIK
10. Lupranat® M20R with an Index of 105, available from BASF SE 0

Chemicals in Reference Examples
1. Lupranol® 3422, sorbitol-based polyol, hydroxyl number 490 mg KOH/g, available from BASF SE
2. Lupranol® 1101/1, glycerine-based ethylene oxide capped with propylene oxide, 160 mg KOH/g
3. Sovermol® 815, branched polyester/polyether triol, hydroxyl number 215 mg KOH/g, available from BASF SE
4. Sovermol® 805, a mixture of castor oil with ketone resin in a mixing ration of about 80:20 parts by weight with a hydroxyl number 173 mg KOH/g, available from BASF SE
5. Pluracol® PEP 450, hydroxyl number 540 mg KOH/g, available from BASF SE
6. Quadrol® L, ethylenediamine propoxylated, BASF SE
7. Lupraphen 6607/1, aliphatic polyester polyol from adipic acid and a mixture of butane diol and hexane diol, weight average molecular weight 2000 g/mol, hydroxyl number 56 mg KOH/g, available from BASF SE
8. Irganox® 1010, pentaerythritol tetrakis(3-(3,5-di-tert-butyl-4-hydroxyphenyl)propionate), available from BASF SE
9. Bicat® 3184M, Zn/Bi/Zr blend catalyst available from The Shepherd Chemical Co, Ohio, USA
10. Lupragen® N203, 1,4-Diazabicyclo-[2,2,2]-octan, available from BASF SE

Analytical Methods Used:
Glass transition temperature by a DSC measurement according to DIN 11357 at a heating rate of 20° C./min
Open time by a rheometer according to the compression test by applying a force of 25 N and a velocity of 0.1 mm/s at a temperature of 23° C., 50% relative humidity (RH)
Bond strength in terms of a lap shear strength at the thickness of 3 mm, within 60 minutes of curing under ambient conditions (23° C.+/−3° C. and 50% rel. hum.+/−10%) followed by 4 h curing at 70° C. (+/−2° C.) in an oven (no humidity control).
Tensile strength by DIN EN ISO 527-2
E-modulus by DIN EN ISO 527-2
Elongation at break by DIN EN ISO 527-2
Hydroxyl number according to DIN 53240

### EXAMPLES

The adhesive compositions of the invention, i.e. example numbers 1 and 2, as well as reference example numbers 1 to 3 according to WO2014/089210 A1, WO2009/080740 A1 and EP2655466 B1, respectively, were prepared according to the ingredients and their amount as shown in table 1. All examples including the reference examples have the same component (C2).

The described procedure applies to the inventive examples 1 and 2.

In order to produce the component C1, the polyol mixture was placed in a vacuum dissolver and agitated after the addition of additives and/or catalyst with the exclusion of moisture for 10 minutes at 25° C. Subsequently, the polyol component C1 was filled into air-tight and moisture-tight cartridge.

In the case of reference examples 1 to 3, the component C2, the polyisocyanate component, i.e. Lupranat® M20 R with an index of 105 , was filled into an air-tight and moisture-tight cartridge. However, in case of examples 1 and 2 of the current invention, diethylene glycol bischloroformate was added to Lupranat® M20R (C1).

TABLE 1
Composition of the Invention i.e. examples 1 and 2, and reference examples 1 to 3

| | | | Reference | Reference | |
|---|---|---|---|---|---|
| | | | example 1 | example 2 | Reference |
| | | | (WO2014/ | (WO2009/ | example 3 |
| Components | Example 1* | Example 2* | 089210A1)* | 080740A1)* | (EP2655466B1)* |
| Polyol component (C1) | | | | | |
| Polyol 4360 | 18.6 | 18.6 | — | — | |
| Dianol ® 330 | 10 | 10 | — | — | 7 |
| Sovermol ® 1079 | 45.4 | 45.4 | — | — | |
| Lupranol ® 3422 | — | — | 8.5 | — | 8 |
| Lupranol ® 1101/1 | — | — | 18.55 | — | — |
| Sovermol ® 815 | — | — | 19.6 | — | — |
| Pluracol ® PEP 450 | — | — | 6.8 | — | — |
| Quadrol ® L | — | — | — | 12.4 | — |
| Lupraphen 6607/1 | — | — | — | 17.3 | — |
| Sovermol ® 805 | — | — | — | — | 31.3 |
| butoxylated TMP | — | — | — | — | 6 |
| Castor Oil | | | 17 | 37 | 16 |
| Lonzacure ® M-DEA | 1.8 | 1.8 | 2.3 | — | 2.2 |
| Fumed Silica | 1.2 | 1.2 | 1 | 4.9 | 1.5 |
| Chalk Filler | 18 | 18 | 20 | 24.7 | 22 |
| Dispersing Agent | 0.2 | 0.2 | 0.1 | — | — |
| Irganox ® 1010 | — | — | — | 0.6 | — |
| Zeolite | 4.7 | 4.7 | 6 | 2.5 | 6 |
| Polycat ® SA 1/10 | 0.1 | — | — | — | — |
| Bicat ® 3184M | — | — | 0.05 | — | — |
| Lupragen ® N203 | — | — | — | 0.15 | — |
| Isocyanate | | | | | |
| component (C2) | | | | | |
| Lupranat ® M20R | 99.9 | 99.9 | 100 | 100 | 100 |
| diethylene glycol | 0.1 | 0.1 | | | |
| bischloroformate | | | | | |
| Index | 104 +/− 2 | 104 +/− 2 | 104 +/− 2 | 104 +/− 2 | 104 +/− 2 |

*all figures given in g

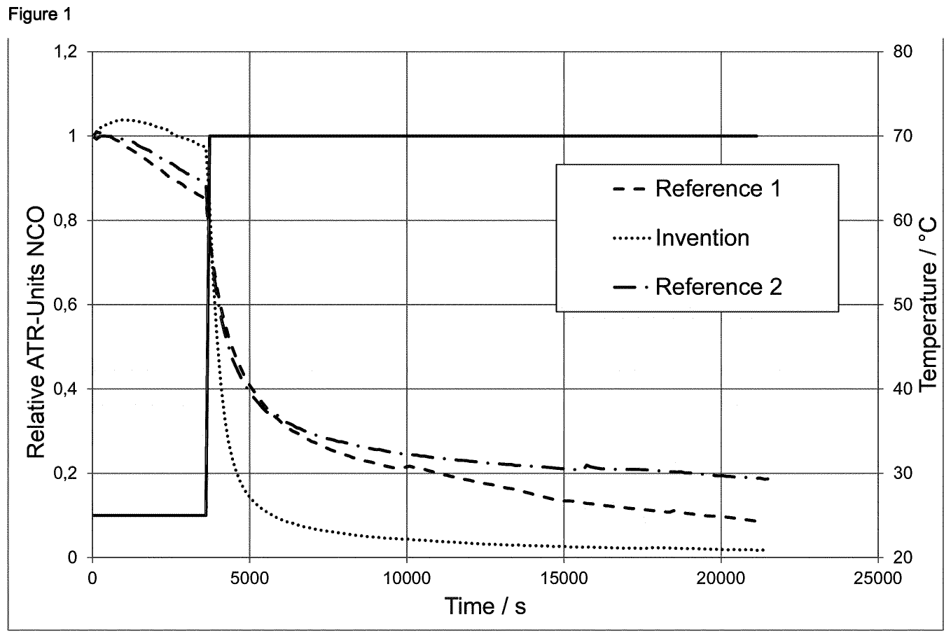

The components (C1) and (C2) were mixed in a static mixer in the weight ratio of (C1):(C2) as shown in table 1. The polyol component (C1) was mixed with component (C2) at an index of 104+/−2. The mixing of (C1) and (C2) was monitored by FT-IR to check the reaction progress. The results are illustrated in FIG. 1.

According to FIG. 1, the decline of the NCO-peak was measured for 1 hour at 25° C. Then the temperature was raised to 70° C. to accelerate the curing process. According to FIG. 1, the catalyst used in example 1 was active at temperature above 80° C.

The properties, namely tensile strength, e-modulus, elongation at break, glass transition temperature, single lap shear and open time for examples 1 and 2 were tested and are reported in table 2. These properties for reference examples 1 to 3 are reproduced from the WO2014/089210A1, WO2009/080740A1 and EP2655466B1, respectively, in table 2.

Besides the improved ratio of open time/curing speed, the adhesive according to the invention offers a thermal stability advantage. For some applications, it is crucial to reach the specific glass transition temperature (Tg). This is very often realized by the usage of high functional polyols like sugar polyols as in reference examples 1 to 3. The high crosslinking density results in a high glass transition temperature. However, examples 1 and 2 used the pentaerythritol based polyol, i.e. polyol 4360 (f=4), that has reduced the network density, but still could raise the glass transition temperature in comparison to the very similar reference example 3 which used the sorbitol based polyol (f=5) that has increased the network density.

However, the examples 1 and 2 of the current invention exhibit a glass transition temperature of 74° C. measured by DSC in comparison to 57° C. as mentioned for reference example 3.

TABLE 2
Properties of the Invention and reference products

| | | | | |
|---|---|---|---|---|
| | | Reference | Reference | |
| | | example 1 | example 2 | Reference |
| | | (WO2014/ | (WO2009/ | example 3 |
| Example 1 | Example 2 | 089210A1) | 080740A1) | (EP2655466B1) |

Neat Resin Properties

| | | | | | | | | | | |
|---|---|---|---|---|---|---|---|---|---|---|
| Tensile strength | 51 | MPa | 51 | MPa | | | | | 35.4 | MPa |
| E-modulus | 3200 | MPa | 3200 | MPa | 1008 | MPa | 2000 | MPa | 1707 | MPa |

| | | | |
|---|---|---|---|
| Elongation at | 3.5% | 3.5% | 3.5% |
| break | | | |

Glass Transition Temperature

| | | | | | | | | |
|---|---|---|---|---|---|---|---|---|
| Tg | 74° | C. | 74° | C. | 60° | C. | 57° | C. |

Adhesion Properties

| | | | | | | | | |
|---|---|---|---|---|---|---|---|---|
| Single Lap Shear | 20 | MPa | 20 | MPa | 20.5 | MPa | 11.5 | MPa |
| (joint thickness) | (3 | mm) | (3 | mm) | (1 | mm) | (2 | mm) |

Processing

| | | | | | | | | |
|---|---|---|---|---|---|---|---|---|
| Open Time | 55 | min | 65 | min | >50 | min | 63 | min |

| | | |
|---|---|---|
| Curing time | 120 min | >240 min |
| | at 70° C. | at 70° C. |

Thus, the two-component polyurethane adhesive of the claimed invention offers a long open time for processing and faster curing with increased thermal stability in comparison to the state of the art products.

1. A two-component polyurethane adhesive comprising:
i. at least one polyol component (C1) comprising:
a) ≥8 to ≤30 wt. % of at least one polyether polyol (P1) having a functionality of 4;
wherein the at least one polyether polyol (P1) is represented by the following formula (I); 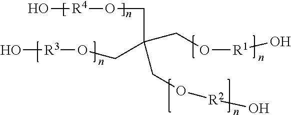
wherein R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂— and
n each, identical or different, is a real number in a range of ≥1 to ≤6,
b) ≥5 to ≤20 wt. % of at least one polyol containing an aromatic moiety (P2), and
c) ≥20 to ≤70 wt. % of at least one polyol derived from a natural oil polyol (P3), whereby the weight percentages relate in each case to an overall amount of the at least one polyol component (C1); and
ii. at least one aromatic polyisocyanate;
whereby the two-component polyurethane adhesive exhibits a glass transition temperature of ≥70° C., the glass transition temperature being determined by a DSC measurement according to DIN 11357 at a heating rate of 20° C./min.

2. The two-component polyurethane adhesive according to claim 1, wherein R¹, R², R³ and R⁴ each, identical or different, are selected from the group consisting of —CH₂—CH₂— and —CH(CH₃)—CH₂—.

3. The two-component polyurethane adhesive according to claim 1, wherein n each, identical or different, is a real number in a range of ≥1 to ≤4.

4. The two-component polyurethane adhesive according to claim 1, wherein the at least one polyether polyol (P1) has a hydroxyl number in a range of ≥150 to ≤700 mg KOH/g.

5. The two-component polyurethane adhesive according to claim 1, wherein the at least one polyol component (C1) comprises ≥10 to ≤25 wt. % of the at least one polyether polyol (P1), whereby the weight percentage relates to the overall amount of the at least one polyol component (C1).

6. The two-component polyurethane adhesive according to claim 1, wherein the at least one polyol containing an aromatic moiety (P2) has a hydroxyl number in a range of ≥130 to ≤340 mg KOH/g.

7. The two-component polyurethane adhesive according claim 1, wherein the at least one polyol component (C1) comprises ≥5 to ≤15 wt. % of the at least one polyol containing an aromatic moiety (P2), whereby the weight percentage relates to the overall amount of the at least one polyol component (C1).

8. The two-component polyurethane adhesive according to claim 1, wherein the aromatic moiety is bisphenol.

9. The two-component polyurethane adhesive according to claim 1, wherein the at least one polyol derived from a natural oil polyol (P3) has a hydroxyl number in a range of ≥150 to ≤250 mg KOH/g.

10. The two-component polyurethane adhesive according to claim 1, wherein the at least one polyol component (C1) comprises ≥25 to ≤60 wt. % of the at least one polyol derived from a natural oil polyol (P3), whereby the weight percentage relates to the overall amount of the at least one polyol component (C1).

11. The two-component polyurethane adhesive according to claim 1, wherein the natural oil polyol is selected from the group consisting of castor oil and natural oil polyols derived from soybean oil, rapeseed oil, coconut oil, peanut oil, palm oil, sunflower oil, olive oil or canola oil.

12. The two-component polyurethane adhesive according to claim 1, wherein the at least one polyol derived from a natural oil polyol (P3) is an alkoxylation product of the natural oil polyol.

13. The two-component polyurethane adhesive according to claim 1, wherein the natural oil polyol is castor oil.

14. The two-component polyurethane adhesive according to claim 1, wherein the at least one polyol component (C1) comprises ≥10 to ≤25 wt. % of the at least one polyether polyol (P1), ≥5 to ≤15 wt. % of the at least one polyol containing an aromatic moiety (P2) ≥25 to ≤60 wt. % of the at least one polyol derived from a natural oil polyol (P3), and ≥10 to ≤40 wt. % of at least one additive selected from the group consisting of chain extenders, water scavengers, fillers, deaerating agents, thixotropic agents, antioxidants, dyes, catalysts, desiccants, resins, plasticizers, wetting agents and pigments, whereby the weight percentages relate to the overall amount of the at least one polyol component (C1).

15. The two-component polyurethane adhesive according to claim 1, wherein the aromatic polyisocyanate further comprises at least one deactivator.

16. The two-component polyurethane adhesive according to claim 15, wherein the at least one deactivator is selected from the group consisting of an aliphatic and an aromatic acid chloride selected from the group consisting of acetyl chloride, benzoyl chloride, benzene sulfonyl chloride, oxalyl chloride, adipyl chloride, sebacyl chloride and carbonyl chloride; an inorganic acid selected from the group consisting of perchloric acid; an organic acid selected from the group consisting of trifluoromethane sulfonic acid and trifluoroacetic acid; and a chloroformate selected from the group consisting of methyl chloroformate, ethyl chloroformate, isopropyl chloroformate, n-butyl chloroformate, sec-butyl chloroformate and diethylene glycol bischloroformate.

17. The two-component polyurethane adhesive according to claim 1, wherein the aromatic polyisocyanate is selected from the group consisting of polymeric methylene diphenyl diisocyanate and polymeric toluene diisocyanate.

18. The two-component polyurethane adhesive according to claim 1, wherein the two-component adhesive comprises ≥0.05 to ≤1.0 wt. % of at least one heat activated catalyst, whereby the weight percentage relates to the overall amount of the at least one polyol component (C1).

19. The two-component polyurethane adhesive according to claim 18, wherein the at least one heat activated catalyst is a cyclic tertiary amine.

20. The two-component polyurethane adhesive according to claim 19, wherein the cyclic tertiary amine is selected from the group consisting of 1,8-diaza-bicyclo[5.4.0]undec-7-ene,1,5-diaza-bicyclo[4.3.0 ]non-5-ene, 1,4 diazabicyclo[2.2.2]octane, N-cetyl-N,N-dimethylamine and dimethyl cyclohexylamine.

21. The two-component polyurethane adhesive according to claim 20, wherein the cyclic tertiary amine is blocked 1,8-diaza-bicyclo[5.4.0]undec-7-ene.

22. The two-component polyurethane adhesive according to claim 1, wherein the two-component polyurethane adhesive comprises ≥10 to ≤40 wt. % of at least one additive, whereby the weight percentage relates to the overall amount of the at least one polyol component (C1).

23. The two-component polyurethane adhesive according to claim 22, wherein the at least one additive is selected from the group consisting of chain extenders, water scavengers, fillers, deaerating agents, thixotropic agents, antioxidants, dyes, catalysts, desiccants, resins, plasticizers, wetting agents and pigments.

24. The two-component polyurethane adhesive according to claim 1, wherein the glass transition temperature is in a range of ≥70 to ≤90° C., the glass transition temperature being determined by the DSC measurement according to DIN 11357 at the heating rate of 20° C./min.

25. A method for producing the two-component polyurethane adhesive according to claim 1, wherein the method comprises the steps of:
A. providing at least one polyol component (C1) comprising:
a) ≥8 to ≤30 wt. % of at least one polyether polyol (P1) having a functionality of 4;
wherein the at least one polyether polyol (P1) is represented by the following formula (I); 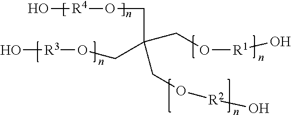
wherein R¹, R², R³ and R⁴ each, identical or different, are selected from the group consisting of —CH₂—CH₂—, —CH(CH₃)—CH₂—, —CH(C₂H₅)—CH₂—, —C(CH₃)₂—CH₂— and —CH₂—CH₂—CH₂—and n each, identical or different, is a real number in a range of ≥1 to ≤6,
b) ≥5 to ≤20 wt. % of at least one polyol containing an aromatic moiety (P2), and
c) ≥20 to ≤70 wt.-% of at least one polyol derived from a natural oil polyol (P3),
whereby the weight percentages relate in each case to an overall amount of the at least one polyol component (C1);
B. providing at least one aromatic polyisocyanate;
C. adding at least one deactivator to the at least one aromatic polyisocyanate of step (B); and
D. mixing the at least one polyol component (C1) of step (A) with the at least one aromatic polyisocyanate of step (C) at an index in a range of ≥102 to ≤108;
to obtain the two-component polyurethane adhesive exhibiting a glass transition temperature of ≤70° C., the glass transition temperature being determined by a DSC measurement according to DIN 11357 at a heating rate of 20° C./min.

26. The method according to claim 25, wherein the index is in a range of ≥102 to ≤106.

27. An article comprising at least one first substrate and one second substrate, wherein the two-component polyurethane adhesive according to claim 1 is present in-between the first substrate and the second substrate of the article and forms an adhesive bond between them.

28. The article according to claim 27, wherein the article is a rotor blade for wind turbines and the first substrate and the second substrate are a first half and a second half of the rotor blade, respectively.

29. A method of manufacturing the an article comprising at least one first substrate and one second substrate, wherein the two-component polyurethane adhesive according to claim 1 is present in-between the first substrate and the second substrate of the article and forms an adhesive bond between them, the method comprising the steps of:
E. applying the two-component polyurethane adhesive onto the at least one first substrate of the article and onto the at least one second substrate of the article;
F. joining the at least one first substrate of the article of step (E) and the at least one second substrate of the article of step (E); and
G. curing the two-component polyurethane adhesive at a temperature in a range of ≥60 to ≤90° C. to form the adhesive bond between the at least one first substrate and the at least one second substrate of the article.

30. A method of manufacturing rotor blades of wind turbines, the method comprising the steps of:
E. applying the two-component polyurethane adhesive according to claim 1 onto a first half of the rotor blade of the wind turbine and onto a second half of the rotor blade of the wind turbine;
F joining the second half of the rotor blade of the wind turbine of step (H) to the first half of the rotor blade of the wind turbine of step (H); and
G. curing the two-component polyurethane adhesive at a temperature in a range of ≥60 to ≤90° C. to form a bond between the first half and second half of the rotor blades of the wind turbine.

31. A method of using the two-component polyurethane adhesive according to claim 1, the method comprising utilizing the two-component polyurethane adhesive for manufacturing rotor blades of wind turbines.
